(19) United States
(12) Patent Application Publication
(10) Pub. No.: US 2008/0295283 A1
(43) Pub. Date: Dec. 4, 2008

(54) SOFT CLOSE DOOR CLOSURE DEVICE

(76) Inventor: Tom Tice, Dolgeville, NY (US)

Correspondence Address: FROMMER LAWRENCE & HAUG, 745 FIFTH AVENUE- 10TH FL., NEW YORK, NY, 10151, US

(21) Appl. No.: 11/757,749

(22) Filed: Jun. 4, 2007

(51) Int. Cl. E05F 3/02; E05C 19/16

(52) U.S. Cl. 16/84; 292/251.5

(57) ABSTRACT

A door closure device that comprises a mounting member having a top surface, a bottom surface, two side surfaces, a back surface and a front surface. The door closure device also includes at least one magnetic member mounted on the mounting member, such that it is recessed in the front surface of the mounting member. The device further includes at least one damping device mounted on the mounting member adjacent to the at least one magnetic member, wherein a portion of the at least one damping device protrudes from the front surface of the mounting member, past the at least one magnetic member on a front face thereof.

### BACKGROUND OF THE INVENTION

1. Field of the Invention

The instant invention relates generally to door closure devices. More particularly, the invention relates to a door closure device that uses a shock absorber or damping device in tandem with a plurality of magnetic members to produce a soft or quiet closing action on, for example, a cabinet door. The invention, however, is easily applicable for use on any door where a soft or quiet closing action is desired.

2. Background of the Invention

There have been several attempts to provide damping devices or shock absorbers for moveable furniture members such as drawers and doors. Early attempts include providing rubber or foam bumpers on the rear portion of the door or on the furniture face frame. These solutions provide a relatively static bumper, which absorbs some of the force of impact, but fails when the door is heavy or traveling at a high rate of speed.

With modern cabinetry and furniture, braking and damping devices are increasingly being used in order to prevent a door of a cabinet or piece of furniture from hitting the cabinet or furniture face frame when the door is slammed shut too forcefully or at a high rate of speed or a drawer which is pushed into a cabinet or piece of furniture with too much force. In the case of drawers, the braking or damping devices are preferably combined with a mating attraction device, such as a magnet. Doors may also be combined with a mating attraction device or, in many instances, they are provided with hinges that have a closure mechanism, which is then responsible, together with the damping device, for an optimum course of closing movement.

One example of a closing or locking device for a door is described in U.S. Pat. No. 4,331,355. The described device is a push-type closing device that comprises a supporting case that houses a drive element, a spring and a driven element. The drive element has a body portion with a catcher, such as a magnet, attached to the front end. Between the rear end of the body of the drive element and the inner surface of the rear wall of the supporting case is disposed a compression coil spring. In use, the closing or locking device is mounted in the door frame of a piece of furniture, for example, a cabinet for electronic equipment. If the catcher is a magnet, an iron attracting plate is mounted on the inside or back side surface of a door in a corresponding position to that of the end of the drive element. Prior to closing of the door, the drive element projects out from the front of the supporting case toward the door. When the door is closed, the drive element is depressed into the supporting case against the tension of the coil spring. In this arrangement, however, because the catcher or magnet is integral to the drive element, a door that is closed is not damped or slowed down prior to impacting the catcher or magnet. Accordingly, the closing action is not a soft, quiet action.

As another example of a closure device, a closure mechanism for a receiver sheet supply drawer of a copier machine is described in U.S. Pat. No. 5,201,512. The closure mechanism in the '512 patent includes a variable damper for damping the movement of the supply drawer from a first, open position to a second, closed position and is said to move the supply drawer towards the second position at a speed sufficiently low to prevent dishevelment of the paper contained within the drawer regardless of the initial speed of the drawer as it leaves its first position.

This damping assembly is located remote from the striker assembly of the '512 patent. In addition, the supply drawer also includes a positioning latch that has a striker assembly and a striker plate assembly. The striker assembly, which is attached to the rear wall of the supply drawer, includes a rod to which a magnet is attached. The striker plate assembly includes a housing that is attached to the frame of the copier machine in a location generally aligned with the magnet of the striker assembly when the striker plate assembly and striker assembly are in a mating relationship. The housing contains a striker plate, formed of a material to which a magnet is attracted. In operation, the striker plate serves to capture the magnet as the striker assembly is brought into close proximity with the striker plate when the supply drawer is moved to its closed position. With this closure mechanism, however, the variable damper and the striker assembly are located in different locations of the supply drawer. Further, the closure mechanism is not designed to be retrofitted on existing copier machines.

Therefore, a need exists for a closure device that can be easily installed on both new and existing cabinets or pieces of furniture. Further, it is desired to provide a closure device which produces a soft, quiet closing action for a cabinet or furniture door.

### SUMMARY AND OBJECTS OF THE INVENTION

It is therefore a general object of the invention to provide a closure device for a door of a cabinet or furniture which overcomes the deficiencies of the prior art.

It is therefore a principal object of the invention to provide a closure device for a door of a cabinet or a piece of furniture that produces or results in a soft, quiet closing action.

Yet another object of the invention is to provide a closure device that provides a damping or braking action for a cabinet or furniture door.

A still further object of the invention is to provide a closure device that automatically closes a door of a cabinet or piece of furniture once it is “captured” by a magnetic member.

These and other objects and advantages are provided by a closure device in accordance with the present invention. In this regard, a door closure device for a door closing system is provided which includes a mounting member that has a top surface, a bottom surface, two side surfaces, a back surface and a front surface. Mounted on the mounting member is at least one magnetic member that is housed within a recessed area provided in the front surface of the mounting member. Also mounted on the mounting member is a damping device or damping means that provides a braking or damping effect to a door or slows down the door as it approaches the closed position. The damping device or means is mounted adjacent to the at least one magnetic member and is mounted such that a portion of the damping device or means protrudes from the front surface of the mounting member, past the front face attracting member of the at least one magnetic member.

In another aspect of the present invention, a door closure system is provided having a mounting member mountable on a stationary body which includes at least one first magnetic member and at least one damping device mounted thereon. The at least one damping device is mounted on the mounting member adjacent to the at least one first magnetic member wherein a portion of the at least one damping member protrudes from a front surface of the mounting member past the at least one first magnetic member which is mounted in a recess so as to be substantially flush with the front surface of the mounting member. At least one second magnetic member is mounted on a movable body which is magnetically attractable to the at least one first magnetic member and wherein as the movable body is moved toward the stationary body by the magnetic attraction of the at least first and second magnetic members, the at least one damping device contacts said movable body to provide for controlled closing movement of the movable body.

The various features of novelty which characterize the invention are pointed out in particularity in the claims annexed to and forming a part of this disclosure. For a better understanding of the invention, its operating advantages and specific objects attained by its uses, reference is made to the accompanying descriptive matter in which preferred embodiments of the invention are illustrated in the accompanying drawings in which corresponding components are identified by the same reference numerals.

### BRIEF DESCRIPTION OF THE DRAWINGS

The following detailed description, given by way of example and not intended to limit the present invention solely thereto, will best be appreciated in conjunction with the accompanying drawings, wherein like reference numerals denote like elements and parts, in which:

FIG. 1 is a perspective view of a closure device for a door closure system, according to one aspect of the instant invention;

FIG. 2 is a perspective view of the closure device and an attracted member of a door closing system installed in a cabinet, according to one aspect of the instant invention specifically showing the cabinet door in an open condition; and

FIG. 3 is a cross-sectional view of the closure member of FIG. 1 taken along line 3-3 of FIG. 1 specifically illustrating the damping or braking member of the closure device.

### DETAILED DESCRIPTION OF CERTAIN PREFERRED EMBODIMENTS OF THE INVENTION

The instant invention will now be described more fully hereinafter with reference to the accompanying drawings, in which preferred embodiments of the invention are shown. This invention may, however, be embodied in many different forms and should not be construed as limited to the illustrated embodiments set forth herein. Rather, these illustrated embodiments are provided so that this disclosure will be thorough and complete, and will fully convey the scope of the invention to those skilled in the art.

Typically, when a user desires to close a door, such as on a kitchen cabinet or a piece of furniture, a user imparts a force on the door in the direction of the cabinet or furniture body. If, however, a user does not hold onto the door until it is closed, the door will usually slam against the body frame of the cabinet, which results in a loud slamming noise. If done repeatedly, this slamming of the door against the cabinet or furniture body can result in damage to the door, the cabinet or furniture face frame or the cabinet or furniture hinges. With the instant device, the chances of such damage can be significantly reduced, if not avoided.

The present invention relates to a closure device for use on doors, such as, but not limited to, kitchen cabinet doors, which, when the door is brought into close proximity with the closure device, the closure device “captures” the corresponding attracted magnetic member on the back side of the door to automatically pull the door closed and keep it closed until opened by a user. Together, the closure device and the attracted magnetic member define a door closure system. The present invention uses magnetic members, such as permanent magnets, in tandem with a damping device or shock absorber provided in close proximity to one of the magnetic members to softly and quietly close the door, regardless of how hard or fast the door is closed by a user. In the following description, like reference characters designate like or corresponding parts throughout the figures.

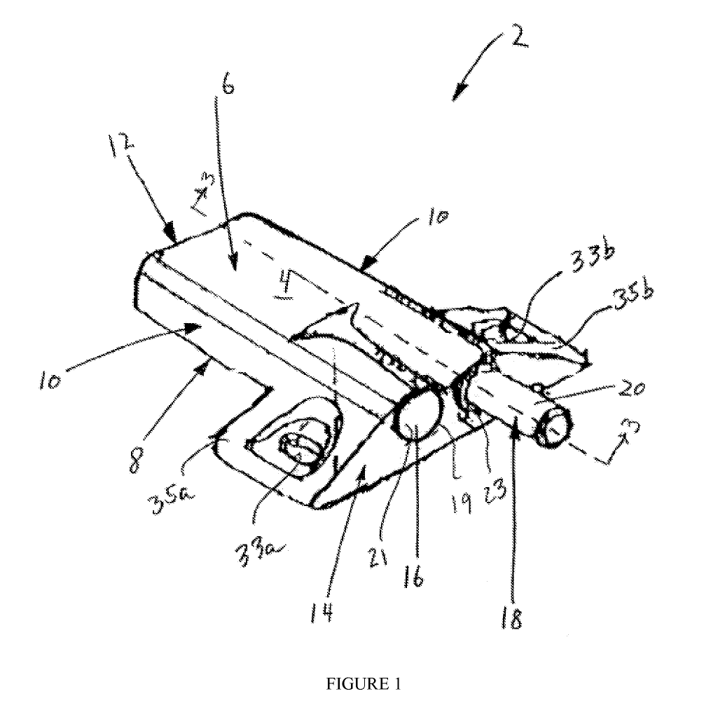

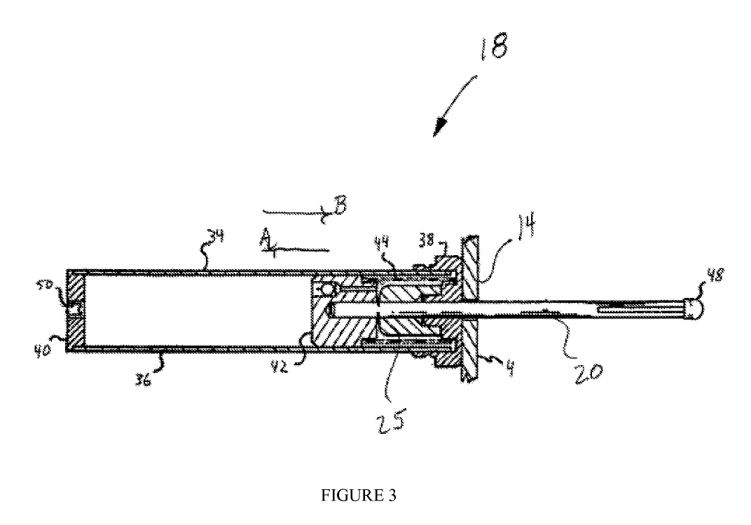

Turning now to the figures, in one embodiment of the present invention depicted in FIG. 1, the closure device 2 of the door closure system includes a mounting member or base 4 having a relatively flat top surface 6, a relatively flat bottom surface 8, two relatively flat side surfaces 10, a back surface 12 and a front surface 14. As can be seen in FIG. 1, at least one first magnetic member 16 and at least one damping device or shock absorber 18 are mounted within the base 4 in a side-by-side relationship. As can further be seen in FIG. 1, the magnetic member 16 is contained within a first recessed cavity 19 longitudinally bored along the axis of the top surface 6 from the front surface 14 of the base 4 such that the front face 21 of the magnetic member 16 is substantially flush with the front surface 14 of the mounting member 4. The damping device 18, however, is mounted in a second recessed cavity 23 (see FIG. 3) longitudinally bored along the axis of the top surface 6 of the mounting member 4 such that a body portion or cylinder thereof 25 (see FIG. 3) is recessed within the mounting member 4 and its plunger portion 20 extends or protrudes from the front surface 14 of the mounting member 4 in the direction of a movable door or furniture piece so that it will be the first element of the closure device 2 to contact a closing door. As such, the first and second recesses permit the magnetic member 16 and a damping device 18 to be respectively contained therein, in a generally parallel, side-by-side relationship.

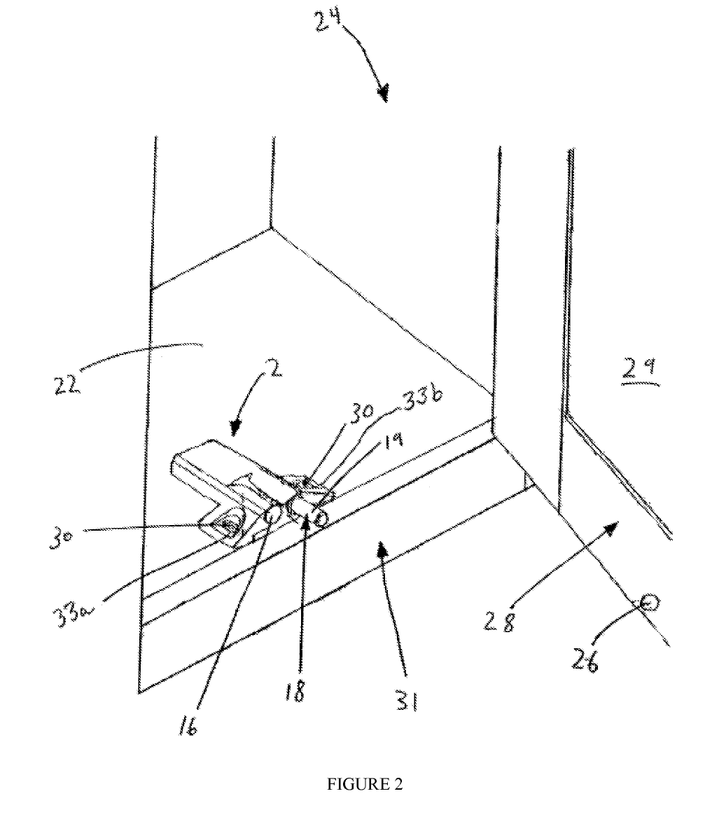

As illustrated in FIG. 2, in one example of the door closure system of the present invention in use, the closure device 2 is mounted on the bottom surface 22 of a cabinet 24, for example, a kitchen cabinet, and a second magnetic member 26 is mounted on a back side 28 of the cabinet door 29 in a corresponding location to that of the magnetic member 16 on the closure device 2, such that when the cabinet door 29 closes, the first and second magnetic members 16 and 26 are in contact, close proximity, or adjacent to, each other. Typically, the closure device 2 attaches to the cabinet 24 by way of a plurality of screws 30 extending through mounting holes 33a and b provided through laterally extending side flanges 35a and b of the base 4 so as to secure the closure device 2 to the floor 22 of the cabinet. However, any mounting means, such as but not limited to, glue or nails may be used. The second magnetic member 26 can be embedded in a receptive cavity (not shown) provided in the back side 28 of the cabinet door 29 or directly affixed thereto by a variety of bonding methods readily known to those of ordinary skill in the art.

As can be seen in FIG. 2, the closure device 2 is mounted on the floor 22 of the cabinet 24 such that the plunger portion 20 of the damping device 18 extends or protrudes past the plane of the front face frame 31 of the cabinet 24. Accordingly, the back side 28 of the cabinet door 29 will contact the plunger portion 20 of the damping device 18 before the door 29 impacts the front face frame 31 of the cabinet 24. It will be readily apparent to those skilled in the art that the closure device 2 can be mounted on any location on the cabinet 24 desired by a manufacturer or user as long as the plunger portion 20 of the damping device 18 extends past the face frame of the cabinet 24.

The mounting member or base 4 can be constructed from any molded or machined material, such as but not limited to, metal (steel, aluminum, etc.) and respective plastic. Additionally, the mounting member can be made from a piece of wood, which can be the same or similar to the wood used to construct the cabinet or piece of furniture. The wood must be, however, of a sufficient strength to accommodate the longitudinal bores of the first and second cavities 19 and 23 of the base 4.

The first and second magnetic members 16 and 26 may be formed of any suitable magnetically conductive material, and charged with magnetic poles of alternating polarity for generating magnetic-adhering faces, i.e., “positive” and “negative” faces. Accordingly, the first and second magnetic members 16 and 26 are mutually magnetically attracted when the door is approaching its closed condition.

In one exemplary embodiment; the first magnetic member 16 and the second magnetic member 26 comprise permanent magnets, such as, but not limited to, neodymium magnets. A permanent magnet is understood by those skilled in the art to be a magnet that retains its magnetism after being removed from a magnetic field. In yet another embodiment, the first magnetic member 16 may be in the form of a permanent magnet, while the second magnetic member 26 may be in the form of a ferromagnetic material such as, for example, iron or steel. In still another embodiment, the first magnetic member 16 may be formed of a ferromagnetic material such as, for example, iron or steel, while the second magnetic member 26 is in the form of a permanent magnet. If both the first and second magnetic members 16 and 26 are permanent magnets, they are mounted in the mounting member 4 and on the cabinet door 29 such that they are attracted to one another, i.e. one magnetic member is mounted with its positive face exposed and the other magnetic member is mounted with its negative face exposed. Depending on the size or weight of the door and the magnetic force necessary to close that particular door, multiple first and second magnetic members may be used to effectively close the door.

A preferred embodiment of the damping device 18 used in the closure member 2 is shown in FIG. 3. In this particular embodiment, the damping device is a variable damper. The variable damper 18, includes a pneumatic (air, for example) cylinder 34 which is received within the recessed cavity 23 (see FIG. 1) and has a hollow tubular body 36 substantially closed by end caps 38 and 40. A piston assembly 42, located within the tubular body 36 in substantial sealing relation therewith, is coupled to the end cap 38 by a tension spring 44 so as to be urged in the direction towards the end cap 38. The piston 42 has a check valve formed therein to permit air flow in one direction (as shown by arrow A in FIG. 3). Accordingly, the movement of the piston in that direction of arrow A in FIG. 3 (toward end cap 40) is restricted. However, upon movement of the piston in the opposite direction of arrow B, air can escape from between the end cap 38 and the piston through the check valve so as to enable the piston 42 to move relatively freely under the urging of the spring 44 toward the end cap 38. The plunger 20 is coupled to the piston 42 and extends outwardly from the tubular body 36 through the end cap 38.

The damping device 18 is supported within the recessed cavity 23 of the mounting member 4 (see FIGS. 1 and 2) such that the plunger 20 outwardly extends from the cabinet body 24 so as to extend towards an approaching cabinet door 29. Accordingly, as the cabinet door 29 closes, the lead end 48 of the plunger 20 having a protected plastic end cup 49 will contact the back side of the cabinet door 29. In addition, a bore 50 is provided through the end cap 40 to control flow of air into and out of the tubular body 36 of the pneumatic cylinder 34. The bore 50 in the end cap 40 of the pneumatic cylinder 34 is particularly configured, for example, to be of a predetermined diameter or may have a restrictor element associated therewith. In this manner, a preselected (controlled) air flow through the bore 50 is established. As is set forth below, the air flow is preselected so as to move the plunger 20 of the piston assembly at a predetermined rate.

When the cabinet door 29 is moved relatively slowly from an open position toward a closed position and the back side of the cabinet door 29 engages the plunger 20 of the pneumatic cylinder 34 to depress the plunger 20 within the tubular housing 36, the air between the piston 42 and the end cap 40 escapes substantially unimpeded from the housing through the bore 50. Thus, the piston 42 moves within the housing 36 substantially unrestricted until the attraction of the magnetic members, 16 and 26, fully closes the door 29. When, however, a door 29 is closed relatively rapidly toward a cabinet or piece of furniture and the back side of the door 29 engages the plunger 20 of the pneumatic piston assembly 42 to depress the plunger 20 within the tubular housing 36, the rate of air escaping from the housing through the bore 50 is insufficient to allow free movement of the piston 42. As such, the movement of the piston 42 within the housing 36 is restricted. This action serves to slow or provide a braking action to the movement of the door 29 as it approaches the closed position. By slowing such movement, any noise or slamming of the door 29 against the cabinet face frame 28, as would occur if the door 29 was suddenly stopped by the cabinet face frame 28, will be minimized, if not completely avoided. Therefore, as the magnetic members, 16 and 26, attract each other to pull the door 29 closed, the damping device 18 controls the rate of closure by absorbing the kinetic energy of the door 29, thereby preventing any slamming of the door against the cabinet, which results in a soft or quiet closing action or process.

Additional non-limiting examples of damping devices, which could be utilized in the closure device 2 of the present invention are disclosed in the below-identified references. These references and all other documents cited or referenced herein (“herein cited documents”), and all documents cited or referenced in herein cited documents, together with any manufacturer's instructions, descriptions, product specifications, and product sheets for any products mentioned herein or in any document incorporated by reference herein, are hereby incorporated herein by reference, and may be employed in the practice of the invention.

For instance, U.S. Pat. No. 7,147,216 relates to a damping device having a cylinder and a piston where the piston has two or more parts. A first piston part is made of a rubber-elastic material forced against the cylinder wall during a damping stroke and the second piston part is made of a material that is stiffer in comparison to the rubber-elastic material.

Additionally, U.S. Pat. No. 7,100,907 relates to a braking and damping device having a fluid cylinder in which two pistons are arranged in a linearly displaceable manner. One of the pistons is displaceable by a piston rod. Arranged between the two pistons is an elastically deformable sealing member, which, when damping occurs, is deformed by being squeezed between the two pistons and pressed against a cylinder wall.

Further, U.S. Pat. No. 6,957,807 is directed to a damping device for damping the kinetic energy of movable cabinet components such as doors. The damping device has a first damping element with a first cylinder that has a first piston that slides lengthwise in the first cylinder, and at least one more (second) damping element with a second cylinder that has a second piston that slides lengthwise in the second cylinder. Both damping elements are located one behind the other in a serial arrangement and form an integral system. The invention is characterized by the fact that each of the two damping elements are each designed as pneumatic (air) dampers, and a compression chamber and an expansion chamber respectively contain variable volumes; whereby the damping effects of the damping elements are affected by guide canals, which control the air distribution and air flow within and between the compression chambers and/or expansion chambers.

In addition, U.S. Pat. No. 6,886,817 is directed to a damping device for movable furniture parts, such as doors, that includes a cylinder filled with a free-flowing medium that is compressed by a piston which has a spring applied to it in its extended position. The cylinder includes a telescopic cylinder having at least two stages. A pressure spring is clamped between the bottom of the outer cylinder of the last stage and the piston of the first stage.

Moreover, U.S. Pat. No. 6,802,408 is directed to a fluid damper for moving furniture parts. The damper includes a cylinder and a piston linearly displaceable within the cylinder. The piston has at least one opening for a damping fluid contained within the cylinder. The damper also includes at least one movable ring disk in the area of the opening(s). The at least one ring disk is arranged such that it at least partially covers the opening(s) of the piston during the damping stroke of the piston.

Still further, U.S. Pat. No. 6,799,663 relates to a damping apparatus for use on movable furniture parts, such as a door. The damping apparatus is constructed as a negative-pressure damping apparatus or a combined pressurized and negative-pressure damping apparatus. The apparatus has a piston and a resiliently deformable piston part in the piston rod. This resiliently deformable piston part is pressurized against the cylinder wall during the damping process.

Yet still further, U.S. Patent Application Publication No. 2004/0227439 relates to a device for damping the movement of movable furniture parts during the closing process. The invention provides for a housing which can be fastened to a fixed wall part or carcass part of a cabinet or piece of furniture, in which housing a lever is pivotably held or a plunger is slidably guided, with said lever or plunger being pivoted or slid to its closing region by the movable furniture part, thus by way of at least a two-stage gear means with a speed increasing ratio impinging on a rotation damper or on the piston of a damping cylinder.

Additional non-limiting examples of damping devices or means are disclosed in U.S. Patent Application Publication Nos.: 2006/0220284; 2006/0207843; 2006/0207057; 2006/0170257; 2006/0118371; 2004/0222682; 2003/0213663; and 2003/0141638.

Although a single damping device 18 is shown in FIGS. 1 through 3 herein, depending on the size and weight of the door, multiple damping devices 18 may be mounted in the mounting frame 4 to more effectively damp the motion of a closing door to produce a soft or quiet closing action based upon the given application.

As will be readily apparent to those skilled in the art, the instant closing device can be adapted for use on all types of doors and is not limited to use on cabinets and other pieces of furniture. For example, the instant closing device can be used on: kitchen or household appliances such as refrigerators and microwaves; all types of household doors including exterior doors, screen doors, interior doors and closet doors; automobile and truck doors and trunks including hatchbacks constructed of glass and/or metal; overhead bins on airplanes, trains and buses; and all types of items that allow a person access to an interior portion thereof through some type of door-like or lid type structure.

Having thus described in detail preferred embodiments of the present invention, it is to be understood that the invention defined by the above paragraphs is not to be limited to particular details set forth in the above description, as many apparent variations thereof are possible without departing from the spirit or scope of the present invention.

Although a preferred embodiment of the present invention and modifications thereof have been described in detail herein, it is to be understood that this invention is not limited to this precise embodiment and modifications, and that other modifications and variations may be effected by one skilled in the art without departing from the spirit and scope of the invention as defined by the appended claims.

What is claimed is:

1. A door closure device comprising:
a mounting member capable of being mountable on a stationary member and including at least one magnetic member capable of magnetically attracting a movable member which is moving toward the substantially stationary member; and
at least one damping device mounted within the mounting member substantially adjacent to said at least one magnetic member, wherein a portion of said at least one damping device protrudes from the mounting member, past the at least one magnetic member, said at least one damping device capable of retarding in a controlled manner the movement of movable member as the movable member approaches the stationary member.

2. The door closure device as claimed in claim 1, wherein the at least one magnetic member is a permanent magnet.

3. The door closure device as claimed in claim 2, wherein the permanent magnet is a neodymium magnet.

4. The door closure device as claimed in claim 1, wherein said at least one magnetic member is mounted in a recessed cavity of said mounting member provided within a front surface thereof.

5. The door closure device as claimed in claim 1, wherein the damping device is a pneumatic device.

6. The door closure device as claimed in claim 1, wherein the mounting member is constructed from a material selected from the group consisting of metal, plastic and wood.

7. The door closure device as claimed in claim 1, wherein said at least one magnetic member and said at least one damping device are mounted on said mounting member in a side-by-side relationship.

8. A door closure system comprising:
a mounting member mountable on a stationary body, and including at least one first magnetic member and at least one damping device mounted thereon with said at least one damping device being mounted on the mounting member adjacent to said at least one first magnetic member, wherein a portion of said at least one damping device protrudes from a front surface of the mounting member, past the at least one first magnetic member which is mounted in a recess so as to be substantially flush with the front surface of the mounting member, and
at least one second magnetic member mounted on a movable body which is magnetically attractable to the at least one first magnetic member and wherein as the movable body is moved toward the stationary body by the magnetic attraction of said at least first and second magnetic members, of said at least one damping device contacts said movable body to provide for controlled movement of said movable body.

9. The door closure system as claimed in claim 8, wherein the at least one first magnetic member mounted on the mounting member is a permanent magnet.

10. The door closure system as claimed in claim 9, wherein the permanent magnet is a neodymium magnet.

11. The door closure system as claimed in claim 8, wherein said at least one first magnetic member comprises a plurality of magnets mounted on the mounting member.

12. The door closure system as claimed in claim 8, wherein said at least one damping device comprises a plurality of damping devices.

13. The door closure system as claimed in claim 8, wherein the damping device is a pneumatic device.

14. The door closure system as claimed in claim 8, wherein said stationary body is a cabinet.

15. The door closure system as claimed in claim 8 wherein said movable body is a cabinet door.

16. The door closure system as claimed in claim 8, wherein the at least one second magnetic member mounted on the movable body is comprised of a ferromagnetic material.

17. The door closure system as claimed in claim 8 which defines an automobile door closure system

18. The door closure system as claimed in claim 8 which defines a household appliance closure system.

19. A shock absorber-type cabinet door stop comprising at least one magnetic member and at least one damping member being placed on a single mounting bracket substantially adjacent to one another.

20. The shock absorber-type cabinet door stop of claim 19 wherein said at least one magnetic member and said at least one damping member are situated on said mounting bracket in a generally side-by-side relationship.

21. The shock absorber-type cabinet door stop of claim 19 wherein said at least one damping member has a pneumatically-actuated air cylinder piston arrangement.

22. The shock absorber-type cabinet door stop of claim 19 wherein said at least one magnetic member and at least one damping member are mounted to the mounting bracket so that a contacting portion of said at least one damping member extends from a front face of said mounting member and past a leading exposed end of said at least one magnetic member which is substantially flush with respect to said front face of said mounting bracket.

23. A shock absorber-type cabinet door stop system comprising:
a first mounting element mountable on a cabinet body and including at least one first magnetic member and at least one damping member both being mounted thereon substantially adjacent to one another in a generally side-by-side relationship,
a second mounting element mountable on a cabinet door and including at least one second magnetic member mounted thereon such that when the second mounting element is moved toward the first mounting element, said at least one first and second magnetic members are attracted to one another and said cabinet door contacts said at least one damping member to damp closing movement of said cabinet door.

24. The shock absorber-type cabinet door of claim 23 wherein said at least one first magnetic member and said at least one damping member are mounted to the first mounting element so that a portion of said at least one damping member which is capable of contacting said cabinet door extends from a front face of said first mounting element and past a leading exposed end of said at least one first magnetic member which is substantially flush with respect to said front face of said first mounting element.

25. The shock absorber-type cabinet door stop system of claim 24 wherein said at least one damping member has a pneumatically-actuated air cylinder piston arrangement.
